(19) United States
(12) Patent Application Publication
(10) Pub. No.: US 2002/0180949 A1
(43) Pub. Date: Dec. 5, 2002

(54) Telemeter

(76) Inventors: Steffen Leutz, Mauer (DE); Gunter Flinspach, Leonberg (DE)

Correspondence Address: Striker Striker & Stenby, 103 East Neck Road, Huntington, NY, 11743, US

(21) Appl. No.: 09/979,596

(22) PCT Filed: Feb. 3, 2001
(86) PCT No.: PCT/DE01/00421

(30) Foreign Application Priority Data
Mar. 23, 2000 (DE) 100 14 539.6

(51) Int. Cl. G01C 3/00; G01C 3/08; G01C 5/00

(52) U.S. Cl. 356/3.1

(57) ABSTRACT

The invention is based on a distance measuring device with a divergently spreading measuring signal, in particular ultrasound and/or radar, and a light pointer (12, 14) comprising at least one light source (10).

It is proposed that a plurality of bundles of light beams (16, 18, 20, 22, 24, 26) that are limited in number and spread divergently from each other can be emitted via the light pointer (12), which basically characterizes the measuring signal with its divergence angle (28).

### PRIOR ART

The invention is based on a distance measuring device according to the preamble of Claim 1.

Ultrasonic measuring devices emit, via a transmitter, a divergently spreading sound wave that is reflected by a target surface of an object and is received by a receiving device of the ultrasonic measuring device. A distance can be determined, for example, by measuring the transmit time of the sound wave.

In order to visualize whether a bearing has been taken on the object as desired, it is known to integrate a light pointer in the distance measuring device, via which a bundle of light beams can be emitted. Either an incadescent lamp is used as the light source, the light of which is bundled via a lens, or a laser is used that emits a bundle of light beams.

### ADVANTAGES OF THE INVENTION

The invention is based on a distance measuring device with a divergently spreading measuring signal, in particular ultrasound and/or radar, and a light pointer comprising at least one light source.

It is proposed that a plurality of bundles of light beams that are limited in number and spread divergently from each other can be emitted via the light pointer, which basically characterizes the measuring signal with its divergence angle. By means of a plurality of divergently spreading bundles of light beams, the divergence angle of the measuring signal and the size of a target surface of the measuring signal can be marked advantageously at a certain distance, e.g., for an operator or for a further device that detects, via an optical receiving unit, the bundles of light beams directly or portions of light of the bundles of light beams reflecting on an object, and evaluates the detected values for the automatic control of a process, e.g., to control a measuring procedure. Measuring errors caused by objects between the distance measuring device and a remote location at which the measuring signal is reflected can be avoided.

Moreover, by means of the limited number of bundles of light beams, the individual bundle of light beams can be designed with a high intensity, and a desired identification of the measuring signal can be achieved over a large distance using a design that is simple in construction, cost-effective, and reliable in terms of performance.

Various light sources that appear appropriate to one skilled in the art can be used, such as incandescent lamps, special high-capacity diodes, etc. The light sources can produce light that is not visible to the human eye and/or, advantageously, visible light, whereby, in addition to a receiving optical system of a second device, the measuring signal with its divergence angle can be detected by an operator.

Particularly advantageously, at least one light source is formed by a laser. With a laser, an advantageous, collimated bundle of light beams and a high light density at great distances can be achieved. The spots of light caused by the bundles of light beams can be well recognized by an operator and a receiving optical system of a second device. The bundles of light beams can be emitted continuously and/or advantageously pulsed. With pulsed bundles of light beams, energy can be saved on the one hand, and, on the other, a stronger observance of the spots of light formed by the bundles of light beams can be achieved.

In a further embodiment of the invention, it is proposed that at least a plurality of bundles of light beams originate from a common light source, and the bundles of light beams diverging from each other are produced from one bundle of light beams via an optical system. Additional light sources, space, weight, assembly expense, and costs can be saved. Basically, the light pointer can also be designed with a plurality of light sources, however, in particular with a plurality of high-capacity diodes.

A bundle of light beams from a light source can be divided into a plurality of bundles of light beams by means of various optical systems that appear appropriate to one skilled in the art, e.g., by means of reflecting and/or light-refracting optical systems, etc. If the light source emits coherent light, however, laser light in particular, the optical system is advantageously designed with a diffractive lens that comprises a diffraction grating. Via the diffraction grating, regions with a constructive interference can be reached, i.e., light regions through which the bundles of light beams emerge, and regions having a destructive interference can be reached, i.e., dark regions through which no light emerges. Diffractive lenses with appropriate diffraction gratings can be installed particularly cost-effectively and simply with great positional tolerance.

A good identification of the measuring signal with its divergence angle is achieved simultaneously with high intensity of the individual bundles of light beams in advantageous fashion in that more than two and fewer than fourteen bundles of light beams can be emitted simultaneously via the light pointer. Particularly advantageously, six bundles of light beams are arranged distributed unevenly or, preferably, evenly on a conical surface.

In a further embodiment it is proposed that a central bundle of light beams can be emitted via the light pointer. With a diffractive optical system in particular, the expense of eliminating a central bundle of light beams can be avoided. The optical system can be designed cost-effectively, and the central bundle of light beams can be used as a directional beam in the distance measurement.

In the cross section in each case, the bundles of light beams can comprise various cross-sectional areas perpendicular to the beam direction. Particularly advantageously, the bundles of light beams comprise basically elliptical cross-sectional areas perpendicular to the beam direction in each case, however, by way of which a lower optical expense can be achieved, i.e., cost-effective optics can be used.

Moreover, the light pointer advantageously comprises a setting unit via which the number of bundles of light beams can be changed. At short distances, a particularly advantageous identification of the measuring signal with its divergence angle can be achieved with a plurality of bundles of light beams and, at great distances, a sufficient intensity can be achieved with few light beams. Individual light sources, e.g., diodes, can be switched on or off via the setting unit, and/or, particularly advantageously, parts of the optical system can be designed to be moveable. For example, lenses can be rotated and/or replaced via the setting unit.

The setting unit can be designed to be operated manually, electrically, or electromagnetically. If the setting unit is operated electrically or electromagnetically, the number of light beams can be automatically adjusted advantageously via a control unit to the distance to be measured, by way of which comfort is increased and a best-possible identification of the measuring signal with its divergence angle can always be achieved.

In a further embodiment of the invention, it is proposed that the light pointer comprise at least one setting unit, via which at least one part of the light pointer can be moved, and at least one bundle of light beams can be emitted in various directions to identify the divergently spreading measuring signal. Using a design that is simple, cost-effective, and reliable in terms of performance, a good identification of the measuring signal with its divergence angle can be achieved at a large distance using few light beams having a high intensity. The setting unit can be designed to be operated manually or, advantageously, electrically or electromagnetically, whereby the bundle of light beams can be automatically adjusted in its direction of radiation in continuous or stepwise fashion during a distance measuring procedure by means of the setting unit.

The light source and/or a part of the optical system of the light pointer can be designed to be moveable via the setting unit. If the light source is formed by a laser, the measuring signal with its divergence angle can be well identified, advantageously, with a small motion.

### DIAGRAM

Further advantages arise from the following description of the diagram. Exemplary embodiments of the invention are presented in the diagram. The diagram, the description, and the claims contain numerous features in combination. One skilled in the art will also advantageously consider the features individually and combine them to appropriate further combinations.

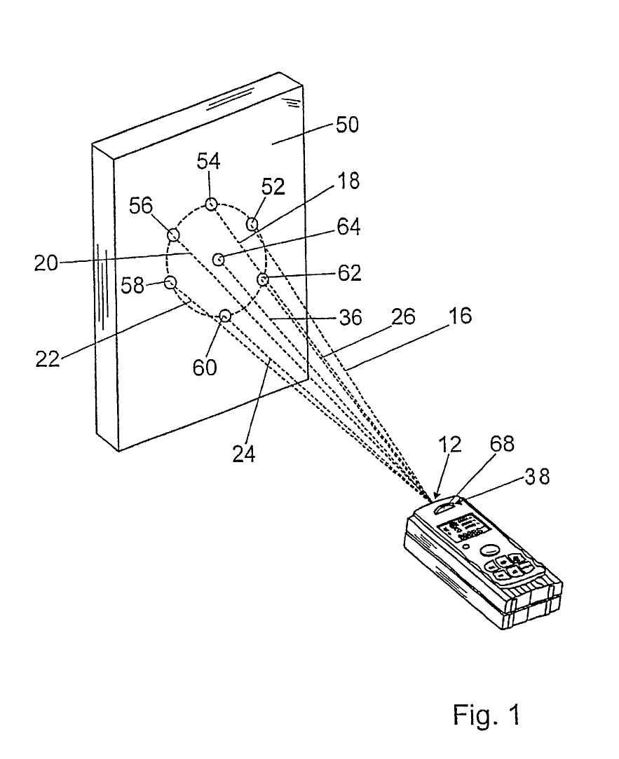

FIG. 1 shows an ultrasonic distance measuring device according to the invention having a light pointer diagonally from above,

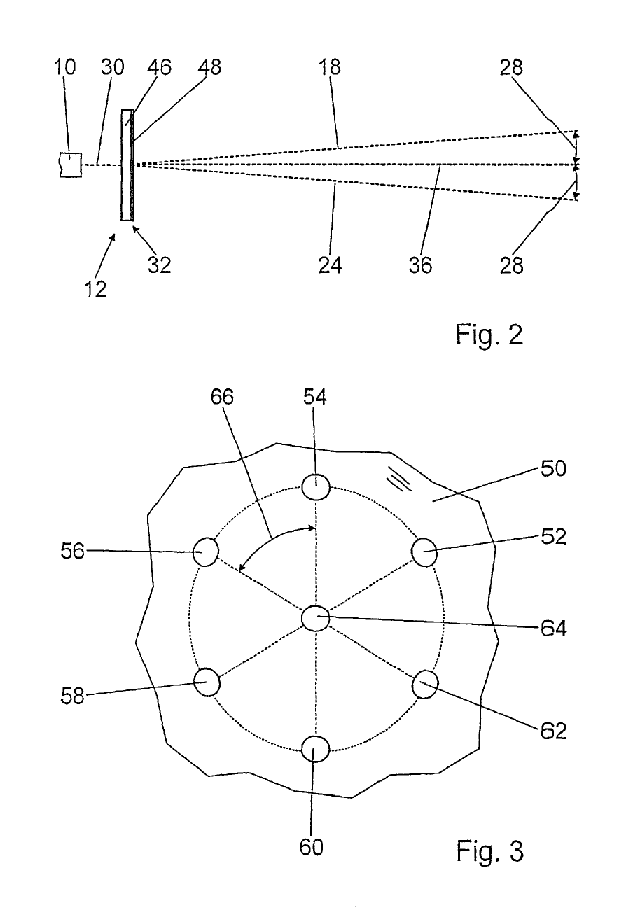

FIG. 2 shows a section of the light pointer from FIG. 1 in a side view,

FIG. 3 shows spots of light on an object produced by the light pointer from FIG. 1,

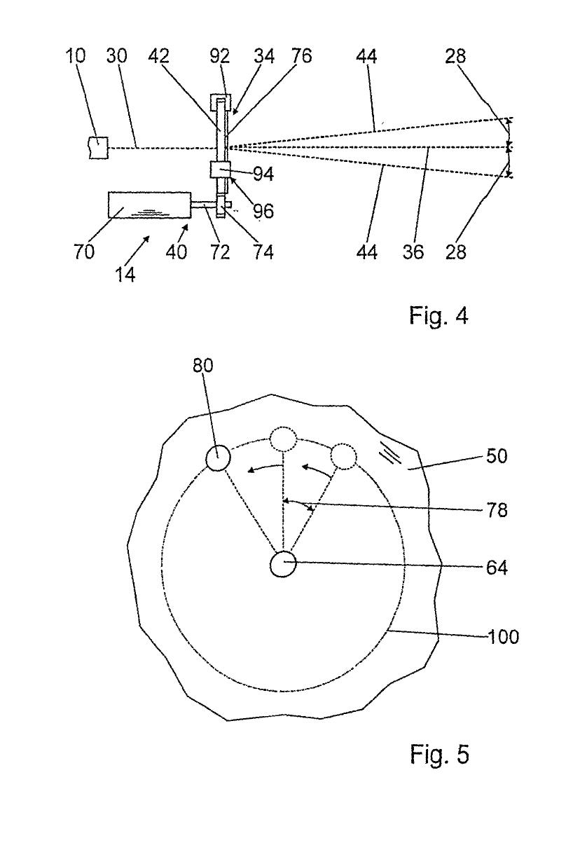

FIG. 4 shows a section of a light pointer with an electrically driven setting unit that is an alternative to FIG. 1,

FIG. 5 shows spots of light on an object produced by the light pointer from FIG. 4, and

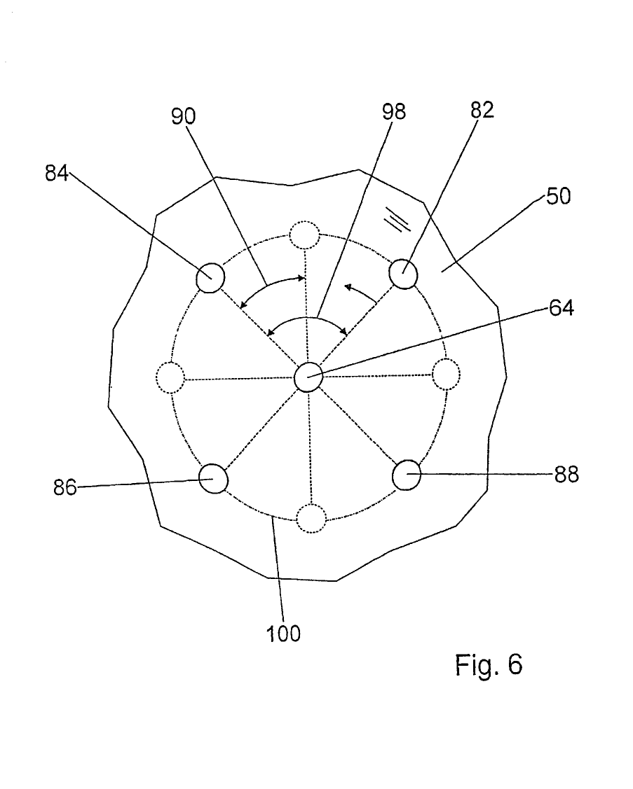

FIG. 6 shows spots of light on an object produced by a light pointer that is an alternative to FIG. 4.

### DESCRIPTION OF THE EXEMPLARY EMBODIMENTS

FIG. 1 shows an ultrasonic distance measuring device with a divergently spreading ultrasonic measuring signal. The ultrasonic distance measuring device has a light pointer 12 with a laser 10 (FIG. 2).

According to the invention, six bundles of light beams 16, 18, 20, 22, 24, 26 spreading divergently from each other can be emitted via the light pointer 12 to identify the measuring signal with its divergence angle. A divergence angle 28 of 5° of the bundles of light beams 16, 18, 20, 22, 24, 26 basically corresponds to the divergence angle of the measuring signal. Depending on the application, the divergence angle of the measuring signal and, therefore, the divergence angle of the bundle of light beams, can also be designed to be larger or smaller than 5°. The bundle of light beams 16, 18, 20, 22, 24, 26 are arranged on a conical surface offset at an angle 66 of 60° in each case (FIG. 3). The individual light beams in a bundle of light beams 16, 18, 20, 22, 24, 26 are basically aligned in parallel to each other. Using the bundles of light beams 16, 18, 20, 22, 24, 26, a target surface of the measuring signal can be made well visible, even at a distance of 20 m.

In addition to the six bundles of light beams 16, 18, 20, 22, 24, 26, the light pointer 12 emits a central bundle of light beams 36 (FIGS. 1 through 3). The bundles of light beams 16, 18, 20, 22, 24, 26, 36 originate from the laser 10 and are produced from one bundle of light beams 30 via a diffractive optical system 32. The optical system 32 comprises a lens 46 with a diffraction grating 48, via which a constructive and a destructive interference can be produced.

The bundles of light beams 16, 18, 20, 22, 24, 26, 36 comprise basically elliptical cross-sectional areas perpendicular to the beam direction and, in each case, produce elliptical spots of light 52, 54, 56, 58, 60, 62, 64 on an object 50 (FIG. 3). The number of bundles of light beams 16, 18, 20, 22, 24, 26 distributed evenly on the conical surface can be increased via a setting unit 38 to three for large distances, and to twelve for particularly short distances. The setting unit 38 comprises a manually-operated adjusting handwheel 68 for this purpose, via which the lens 46 can be rotated.

A section of an alternative light pointer 14 is presented in FIGS. 4 and 5. Components that basically remain the same are labelled with the same reference numbers. Moreover, the description of the exemplary embodiment in FIGS. 1 and 3 can be referred to with regard for features and functions that remain the same.

The light pointer 14 comprises a setting unit 40 with an electric motor 70 with which a lens 42 of an optical system 34 can be rotated in stepwise fashion via a drive shaft 72 and a toothed wheel 74. The lens 42 comprises a diffraction grating 76, via which a central bundle of light beams 36 can be produced from a bundle of light beams 30 of a laser 10, and a second bundle of light beams 44 with a divergence angle 28 of 5° from the central bundle of light beams 36 can be produced.

The laser 10 is operated in pulsed fashion during a distance measuring procedure. As soon as the laser 10 is turned off, the electric motor 70 rotates the lens 42 further at an angle 78 of 40° (FIG. 5). The lens 42 is supported in rotatable fashion in three bearing components 92, 94, 96. By means of the rotary motion, the bundle of light beams 44 for identifying the divergently spreading measuring signal is emitted in different directions, and, in fact, the bundle of light beams 44 is adjusted perpendicularly to the beam direction along a conical surface. An elliptical spot of light 80 which runs along a circular path 100 is produced on an object 50.

FIG. 6 shows spots of light 64, 82, 84, 86, 88 produced on an object 50 by a light pointer that is an alternative to FIG. 4 and is not presented further. Instead of two bundles of light beams, five bundles of light beams are produced with one lens. Four of the bundles of light beams are arranged on a conical surface offset at an angle 98 of 90° in each case. When the laser is turned off, the lens is rotated further in stepwise fashion at an angle 90 of 45° in each case via a setting unit.

Reference Numbers

| | | | |
|---|---|---|---|
| 10 | Light source | 56 | Spot of light |
| 12 | Light pointer | 58 | Spot of light |
| 14 | Light pointer | 60 | Spot of light |
| 16 | Bundle of light beams | 62 | Spot of light |
| 18 | Bundle of light beams | 64 | Spot of light |
| 20 | Bundle of light beams | 66 | Angle |
| 22 | Bundle of light beams | 68 | Adjusting handwheel |
| 24 | Bundle of light beams | 70 | Electric motor |
| 26 | Bundle of light beams | 72 | Drive shaft |
| 28 | Divergence angle | 74 | Toothed wheel |
| 30 | Bundle of light beams | 76 | Diffraction grating |
| 32 | Optical system | 78 | Angle |
| 34 | Optical system | 80 | Spot of light |
| 36 | Bundle of light beams | 82 | Spot of light |
| 38 | Setting unit | 84 | Spot of light |
| 40 | Setting unit | 86 | Spot of light |
| 42 | Part | 88 | Spot of light |
| 44 | Bundle of light beams | 90 | Angle |
| 46 | Lens | 92 | Bearing component |
| 48 | Diffraction grating | 94 | Bearing component |
| 50 | Object | 96 | Bearing component |
| 52 | Spot of light | 98 | Angle |
| 54 | Spot of light | 100 | Circular path |

1. Distance measuring device with a divergently spreading measuring signal, in particular ultrasound and/or radar, and a light pointer (12, 14 ) comprising at least one light source (10), characterized in that a plurality of light beams (16, 18, 20, 22, 24, 26) that are limited in number and spread divergently from each other can be emitted via the light pointer (12), which basically characterizes the measuring signal with its divergence angle (28).

2. Distance measuring device according to claim 1, characterized in that at least one light source (10) is formed by a laser.

3. Distance measuring device according to claim 1 or 2, characterized in that at least a plurality of bundles of light beams (16, 18, 20, 22, 24, 26) originate from a common light source (10), and the bundles of light beams (16, 18, 20, 22, 24, 26) diverging from each other are produced from a common bundle of light beams (30) via an optical system (32).

4. Distance measuring device according to claim 3, characterized in that more than two and fewer than fourteen bundles of light beams (16, 18, 20, 22, 24, 26) can be emitted simultaneously via the light pointer (12).

5. Distance measuring device according to one of the preceding claims, characterized in that a central bundle of light beams (36) can be emitted via the light pointer (12).

6. Distance measuring device according to one of the preceding claims, characterized in that the bundles of light beams (16, 18, 20, 22, 24, 26, 36) comprise basically elliptical cross-sectional areas perpendicular to the beam direction in each case.

7. Distance measuring device according to one of the preceding claims, characterized in that the light pointer (12) comprises a setting unit (38), via which the number of bundles of light beams (16, 18, 20, 22, 24, 26, 36) can be changed.

8. Distance measuring device according to claim 7, characterized in that the setting unit is operated electrically or electromagnetically, and a control unit sets the number of bundles of light beams depending on a distance to be measured.

9. Distance measuring device according to the preamble of claim 1 or according to one of the preceding claims, characterized in that the light pointer (14) comprises at least one setting unit (40), via which at least one part (42) of the light pointer (14) can be moved, and at least one bundle of light beams (44) can be emitted in various directions to characterize the divergently spreading measuring signal.

10. Distance measuring device according to claim 9, characterized in that one part (42) of an optical system (34) of the light pointer (14) can be moved via the setting unit (40).

11. Distance measuring device according to claim 9 or 10, characterized in that at least one light source of the light pointer can be moved via the setting unit.
